(19) United States
(12) Patent Application Publication
(10) Pub. No.: US 2011/0174698 A1
(43) Pub. Date: Jul. 21, 2011

(54) FRACTIONATING ARRANGEMENT

(76) Inventors: Jonas Bergström, Aulendorf (DE); Reinhard Bluhm, Baienfurt (DE); Tillman Katzenmeier, Ravensburg (DE); Wolfgang Mannes, Ravensburg (DE); Marc Perrin, Francin (FR)

(21) Appl. No.: 13/004,457

(22) Filed: Jan. 11, 2011

Related U.S. Application Data
(63) Continuation of application No. PCT/EP2009/060202, filed on Aug. 6, 2009.

(30) Foreign Application Priority Data
Aug. 11, 2008 (FR) 0855504
Apr. 9, 2009 (DE) 10 2009 017 187.8

(51) Int. Cl. B03B 5/56; B07B 7/06

(52) U.S. Cl. 209/240; 209/250

(57) ABSTRACT

The invention relates to an arrangement for fractionating a suspension of fibrous material suitable for creating a web of paper, board, tissue or some other fibrous material into a short fiber fraction with a high proportion of short and/or stiff fibers and/or vessel cells and a long fiber fraction with a high proportion of long and/or flexible fibers, comprising a screen element with screen openings which is taken past at least one nozzle which directs a jet of the fibrous material suspension onto the screen element, wherein the long fiber fraction is collected on the side of the screen element that is facing the nozzle and the short fiber fraction is collected on the opposite side of the screen element. In this case it is intended to make the fractionating easier and/or more efficient by the screen element being cylindrically formed and mounted rotatably about the cylinder axis and/or by most of the screen openings, preferably all the screen openings, being formed as elongated slits which extend, at least over part of their length, in an inclined manner in relation to the direction of movement of the screen element, or by the screen element having a honeycomb structure.

### CROSS REFERENCE TO RELATED APPLICATIONS

This is a continuation of PCT application No. PCT/EP2009/060202, entitled “Fractionating Arrangement”, filed Aug. 6, 2009, which is incorporated herein by reference.

### BACKGROUND OF THE INVENTION

1. Field of the Invention

The invention relates to an arrangement for fractionating a fibrous material suspension suitable for producing a web of paper, board, tissue or other fibrous material into a short fiber fraction with a high proportion of short and/or stiff fibers and/or vessel cells and a long fiber fraction with a high proportion of long and/or flexible fibers, including a screen element with screen openings which is led past at least one nozzle that directs a jet of the fibrous material suspension onto the screen element, the long fiber fraction being collected on the side of the screen element that faces the nozzle and the short fiber fraction being collected on the opposite side of the screen element.

2. Description of the Related Art

When a new fibrous material suspension is prepared from wood or when recovered paper is converted into a fibrous material suspension, the fibers generally have very different lengths. It can then be advantageous to separate the short pulp fibers from long pulp fibers, primarily in order to be able to produce paper sheets with different qualities.

In this case, the aim is usually firstly to obtain a short fiber fraction, which predominantly contains short fibers whose maximum lengths are of the order of magnitude of one millimeter to one and a half millimeters, and secondly to obtain a long fiber fraction which predominantly contains long fibers whose minimum lengths are of the order of magnitude of one millimeter to one and a half millimeters. Obtaining a long fiber fraction which contains long fibers and is free of mineral contents can likewise be of interest.

Normally, however, such arrangements are used to prepare waste paper fiber raw materials to such an extent that they can be used again as raw material for the production of webs of fibrous material.

Mixed waste paper often comprises different grades and, as compared with fresh pulp, has a relatively wide fiber length spectrum.

In this regard, DE 2018510 discloses the practice of spraying the fibrous material suspension onto a perforated screen, but the holes tend to block.

In WO 01/29297 it is therefore proposed to lead a screen element past a nozzle. Here, the screen element is formed from wires or the like, which run in the direction of movement of the screen. The nozzle is located outside the loop of the screen element. This can also be unsatisfactory with respect to the fractionating effect.

What is needed in the art is to configure the fractionation to be simpler and, if possible, also more efficient.

### SUMMARY OF THE INVENTION

The present invention provides firstly that the screen element is of cylindrical design and is mounted such that it can be rotated about the cylinder axis.

Irrespective of the configuration of the screen openings, this is associated with advantages in production and function. In addition, this permits a stable shape of the screen element.

Here, the predominant part of the screen openings, preferably all the screen openings, should be formed as elongated slots. At least in some sections, these can be inclined in the direction of movement of the screen element, i.e. in the direction of rotation or at an angle to the latter, in particular run at right angles to the latter.

For the removal of the short and long fiber fraction, it is advantageous if the cylinder axis of the screen element runs approximately vertically. In this arrangement, at least one fraction can at least to some extent be collected simply underneath the cylinder.

The slots can be formed by rods spaced apart from one another, it being possible for the slots to be bounded by spacers between the lands. In this case, the rods extend over a part of the length of the cylinder but preferably over the entire length of the cylinder.

Here, the rods can have a round cross section or else a multi-angled, in particular a rectangular cross section with two long side surfaces. A round cross section is to be preferred if blockage of the slots is to be feared.

In the case of a rectangular cross section, there is the possibility of arranging the rods such that the long side surfaces run radially. In this way, the slots extend in the radial direction over the long side surfaces, which is conducive not only to the stability of the screen element but also to the fractionation.

In order to make it easier to remove the fibrous material accumulating in the cylindrical screen element, the cylindrical screen element can be designed to be open at the bottom.

The nozzles can be arranged inside or else outside the cylindrical screen element.

Above all if the rods have a rectangular cross section with radially oriented, long side surfaces, the arrangement of the nozzles inside the cylindrical screen element has advantages. In this case, the slot width widens radially toward the outside, even if only slightly, which reduces the risk of blockage of the slots.

The fibrous material which does not pass through the slots forms the long fiber fraction. In the case of an arrangement of the nozzles inside the screen element, a collecting trough for the long fiber fraction should therefore be arranged underneath the cylindrical screen element.

In this case, it is possible for the long fibers to be caught on the rods. In order to detach these from the rods, at least in each case a pressurized fluid nozzle should be arranged outside the cylindrical screen element after a nozzle in the direction of movement which pressurized fluid nozzle directs a fluid, in particular steam, water or compressed air, onto the screen element. The long fibers detached from the rods then fall into the collecting trough.

Accordingly, at least one collecting trough for the short fiber fraction should be arranged outside the cylindrical screen element, opposite and/or underneath a fibrous material suspension nozzle.

If the fibrous material suspension nozzles are arranged outside the cylindrical screen element, then the short fibers inside the cylindrical screen element must be picked up by a collecting trough for the short fiber fraction. In order to assist this, this collecting trough can be connected to a vacuum source, so that the vacuum sucks the short fibers into the collecting trough. In order to detach the long fibers hanging on the rods, then at least in each case a pressurized fluid nozzle should be arranged inside the cylindrical screen element after a nozzle in the direction of movement which pressurized fluid nozzle directs a fluid, preferably water, steam or compressed air, onto the screen element. The long fibers detached from the rods can thus be collected by at least one collecting trough for the long fiber fraction outside the cylindrical screen element, opposite and/or underneath the corresponding fluid nozzle.

Irrespective of the formation of the screen element, it is important to the invention that the predominant part of the screen openings, preferably all the screen openings, are formed as elongated slots which, at least in some sections, run at an angle to the direction of movement of the screen element, in particular at right angles to said direction.

This is therefore advantageous in particular since the fibers are preferably oriented in the flow direction by the acceleration in the suspension nozzle and thus, in the case of lands running transversely, the probability that they are caught on the latter is high.

In order to simplify fabrication and in the interest of uniform fractionation, the predominant part of the slots, preferably all the slots, of the screen element should be formed identically.

In this connection, it is furthermore advantageous if the predominant part of the slots, preferably all the slots, of the screen element are oriented identically.

Depending on the desired fractionation result, the width of the slots of the screen element should be between 0.3 and 3 mm, preferably between 0.5 and 1.5 mm.

Irrespective of the shape of the screen element, it is likewise important to the invention that the screen element has a honeycomb structure. The honeycomb structure provides high stability with a large open area as compared with parallel rods.

Irrespective of the shape of the screen openings, it can be advantageous if the screen element is formed as an endlessly circulating, flexible screen belt, which preferably consists of plastic because of the bending stress. In this case, the screen belt can be guided in the open or in a housing. Although guidance in a housing is more complicated, it is also cleaner.

Alternatively, it can be advantageous if the screen belt is formed by rods spaced apart transversely with respect to the direction of movement and from one another, which are preferably connected to one another at the ends and/or at specific intervals transversely with respect to the direction of movement of the screen belt, and consist of metal. In this way, slots running virtually over the entire length of the rods are formed between the rods.

The connection between the rods can be made via flexible plastic connections.

In order to limit the loading of the screen belt, the latter should be deflected over rotating guide rolls.

For the purpose of fractionation, the fibrous material suspension nozzles should be arranged only on one side of the screen belt and in each case direct a fibrous material suspension jet preferably into the inlet pocket between the screen belt and a guide roll. While the short fibers pass through the screen openings to the greatest extent, the long fibers are caught on the lands of the screen belt.

During the wrap around the guide roll, the screen openings on the side of the screen belt that is located on the outside during the wrap are also spread out. The enlargement of the screen openings on this side improves the throughput of the short fibers.

After this guide roll, the screen belt should then be curved in the opposite direction, preferably by wrapping around a following guide roll. In this way, the screen openings on the side of the screen belt on which the long fibers have caught spread out, which makes the removal of the latter easier.

In this case, it is also possible to use pressurized fluid nozzles, which are arranged on the side of the screen belt opposite to the fibrous material suspension nozzles and are arranged after the latter and direct the fluid onto the screen belt. The fluid flows through the screen openings and tears the long fibers away from the screen belt on the opposite side.

Ideally, the belt does not rest directly with the lands on the guide rolls but, for this purpose, has elevated running surfaces, which can preferably be formed by the plastic connections.

Accordingly, at least one collecting trough for the fibrous material should be arranged in each case on each side of the screen belt. While it is the long fibers on the side of the screen belt having the fibrous material suspension nozzles that are enriched, it is the short fibers on the opposite side.

An increase in the throughput is easily possible, for example, if a plurality of fibrous material suspension nozzles are arranged one after another in the direction of movement of the screen belt and/or beside one another transversely with respect to the direction of movement.

Advantageously, irrespective of the shape of the screen openings and the configuration of the screen element, the total area of the screen openings should be more than 50% of the total area of the screen element.

Because of the large open area of the screen element, in conjunction with a large number of screen openings having a small extent necessary for the fractionation, the result is a small land width between the screen openings.

The small land width permits efficient fractionation, the average land width between the screen openings being less than 2 mm, preferably less than 1 mm and in particular between 0.3 and 0.8 mm.

In order to impart sufficient stability to the screen element despite the low land width, it is advantageous if the thickness of the screen element is more than two times, preferably three times, the average land width between the screen openings.

In the interest of a high throughput of the fibrous material suspension to be fractionated, a plurality of nozzles should in each case direct at least one jet of fibrous material suspension onto the screen element.

Since vessel cells and also short and/or stiff fibers pass through the screen openings more easily, it is possible not only for enrichment of short fibers but also of stiff fibers, i.e. in particular of fibers with a high lignin content, to take place in the short fiber fraction, as it is known.

The long fibers, but in particular the flexible fibers, are predominantly deposited on the lands between the screen openings and form what is known as the long fiber fraction.

Since fibers with a low lignin content are flexible, these can be enriched in the long fiber fraction.

Accordingly, by using the fractionator, it is possible for fractionation to be carried out not only according to the fiber lengths but also according to the lignin content.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic illustration of a fractionator;

FIG. 2 shows a cross section through the latter;

FIG. 3 shows a detail of a screen element 1 having a honeycomb structure;

FIG. 4 shows a screen belt having rods 2;

FIG. 5 shows a plan view of a fractionator having a screen belt;

FIG. 6 shows a screen element 1 having spacers 13;

FIG. 7 shows another form of a screen opening 3;

FIG. 8 shows a horizontal section along I from FIG. 9 of a fractionator;

FIG. 9 shows a vertical section along II of the apparatus from FIG. 8;

FIG. 10 shows another vertical section along III of the apparatus from FIG. 8;

FIG. 11 shows a horizontal section of another fractionator; and

FIG. 12 shows an enlarged partial cross section through a screen element 1.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

Referring now to the drawings, and more particularly to FIG. 1, there is shown a fractionator which is formed by a rotating cylindrical screen element 1. Here, the vertically arranged cylinder jacket comprises rigid rods 2 of metal running axially and spaced apart from one another, which are fixed to the upper cylinder side disk 10 via fixing elements 9.

The rods 2 run over the entire length of the cylinder and in each case form between themselves screen openings 3 in the form of a very long gap or slot.

The slots have a width between 0.3 and 3, preferably between 0.5 and 1.5 mm, and thus extend at right angles with respect to the direction of rotation 8 of the screen element 1.

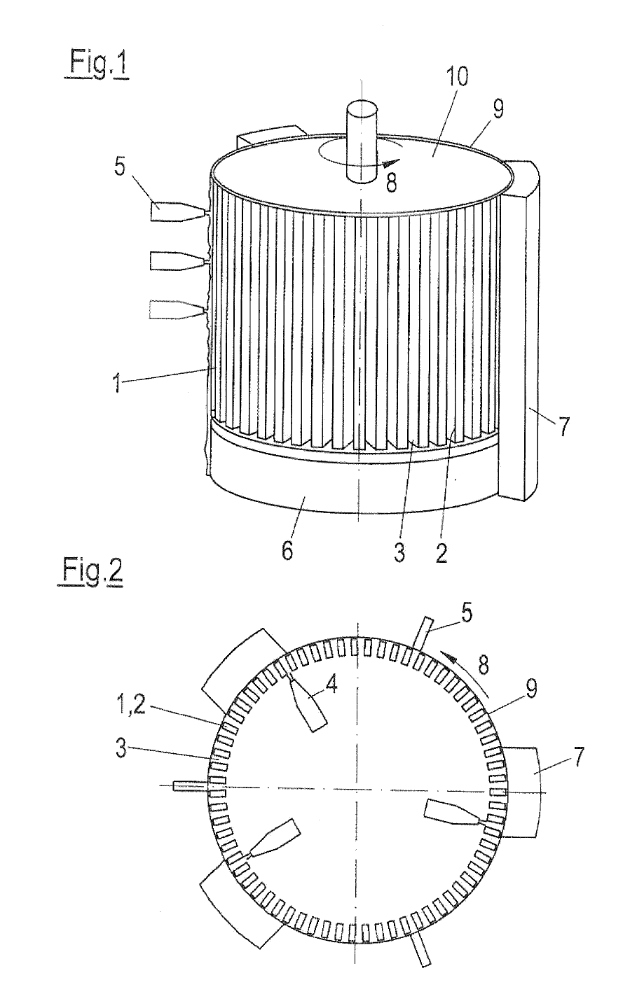

As can be seen in FIG. 2, the rods 2 have a rectangular cross section with two long side surfaces which run radially with respect to the cylinder.

Within the cylindrical screen element 1 here, by way of example, there are three nozzles 4 arranged distributed over the circumference, which in each case direct a jet of the fibrous material suspension toward the screen element 1. The nozzles 4 are able to direct the jet onto the slots 3 perpendicularly or at an angle.

Here, the short fibers 20 pass through the slots 3 without difficulty, while the long fibers 19 bounce off or are caught on the rods 2. Since the screen element 1 rotates, the long fibers 19 that are caught move out of the range of the nozzle 4, which prevents blockage of the slots 3.

On the side of the screen element 1 opposite to the nozzles 4 there is in each case a collecting trough 7 for receiving and transporting away the short fibers 20 and the part of the water from the fibrous material suspension that has passed through the slots 3.

In order to detach the long fibers 19 from the rods 2, air nozzles 5 in each case arranged outside the cylindrical screen element 1 after a nozzle 4 in the direction of movement 8 direct compressed air onto the screen element 1. The long fibers 19 detached in this way, together with the long fibers 19 that have already bounced off during the spraying, and the remainder of the water from the fibrous material suspension is picked up by a collecting trough 6 arranged under the cylindrical screen element 1.

As an alternative to the rods 2, the screen element 1 can also have a honeycomb structure, as illustrated in FIG. 3, which likewise permits low land widths.

If the screen element 1 is not subjected to any bending, then the honeycomb structure can consist of metal, in another case of plastic.

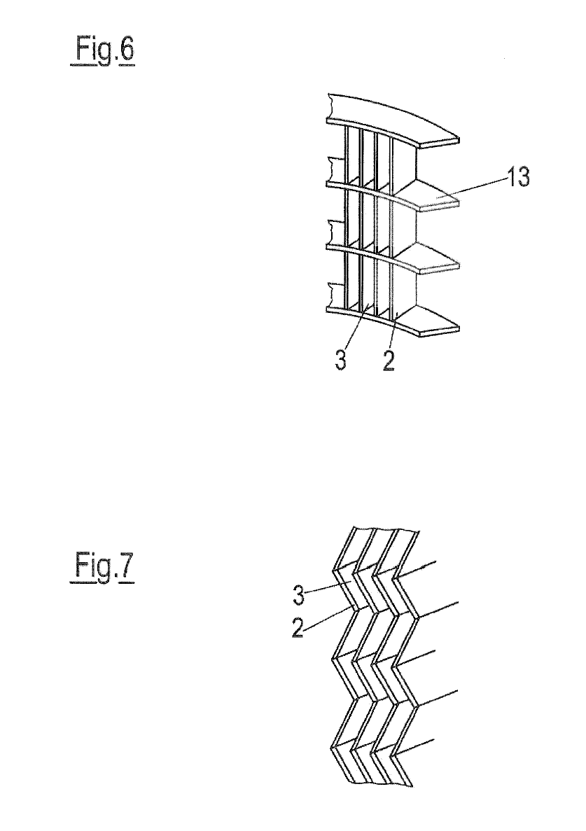

According to the illustration in FIG. 6, the slots 3 can also be interrupted by rings, running radially here, which function as spacers 13 to stabilize the structure and to fix the slot width.

Depending on the location of use and the requirements, the slots 3 can also run at an angle or at an angle in sections, so that the result is a zigzag-shaped slot 3, for example, as can be seen in FIG. 7.

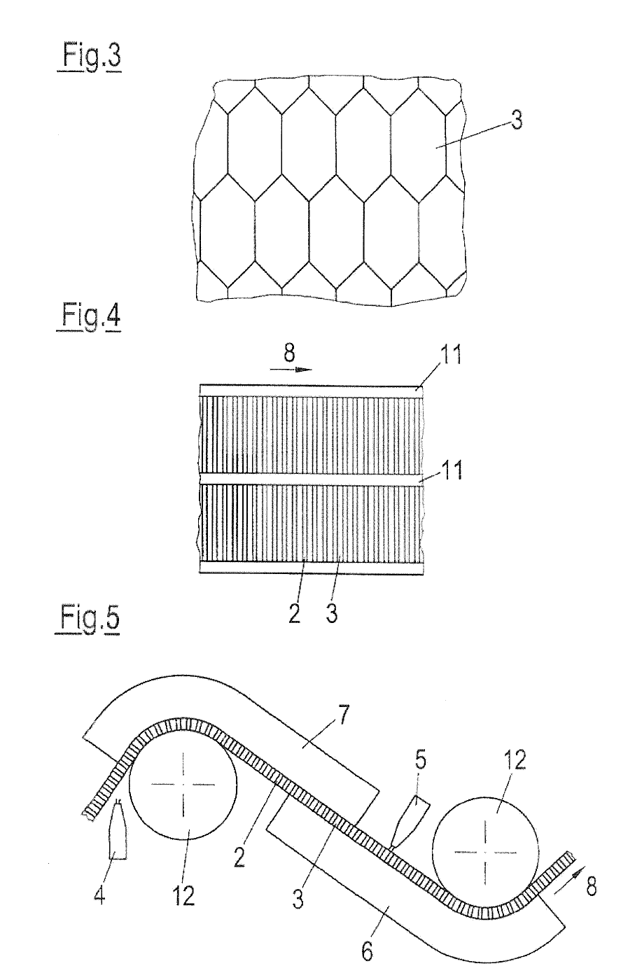

In the embodiment shown in FIGS. 4 and 5, the screen element 1 is formed by an endlessly circulating, flexible screen belt.

This screen belt can have a honeycomb structure or else, as can be seen in FIG. 4, can have rigid rods 2 of metal. In this case, the mutually spaced rods 2 run transversely with respect to the direction of movement 8 of the screen belt. The connection between the rods 2 is made via a flexible plastic connection 11 at the ends of the rods 2 and in the middle.

The plastic connections 11 can be used as elevated running surfaces during the deflection on the guide rolls 12 and/or can be arranged at specific intervals transversely with respect to the direction of movement 8 of the screen belt.

On its path, the screen belt is deflected repeatedly over rotating guide rolls 12. At least before one guide roll 12, a nozzle 4 directs a jet with fibrous material suspension to be fractionated into the inlet pocket between screen belt and guide roll 12.

The short fibers 20 of the fibrous material suspension pass through the screen openings 3 and are picked up by a collecting trough 7 on this side. After that, the screen belt wraps around a guide roll 12 on the opposite side, which is intended to lead to the detachment of the long fibers 19 of the fibrous material suspension that have been caught on this side.

Accordingly, the collecting trough 6 for the long fibers 19 is also located on the side of the screen belt having the nozzles 4. In order to further assist the detachment of the long fibers 19, a pressurized fluid, for example water or compressed air, can be directed by fluid nozzles 5 at the side of the screen belt that is opposite to the fibrous material suspension nozzles 4.

In every case, the open area of the screen element 1 formed by the screen openings 3 corresponds to more than 50% of the effective surface of the screen element 1. In conjunction with a multiplicity of relatively small screen openings 3 required to retain the long fibers 19, the result in this case is also very narrow land widths of on average or at least predominantly at most 2 mm.

As a result, this permits very efficient fractionation.

In order to ensure adequate stability, the screen element 1 is designed to be correspondingly thick.

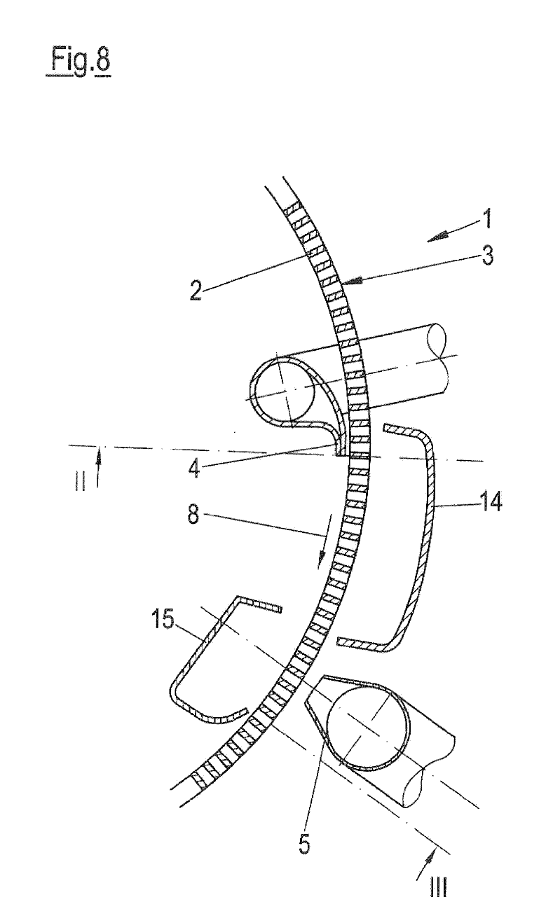

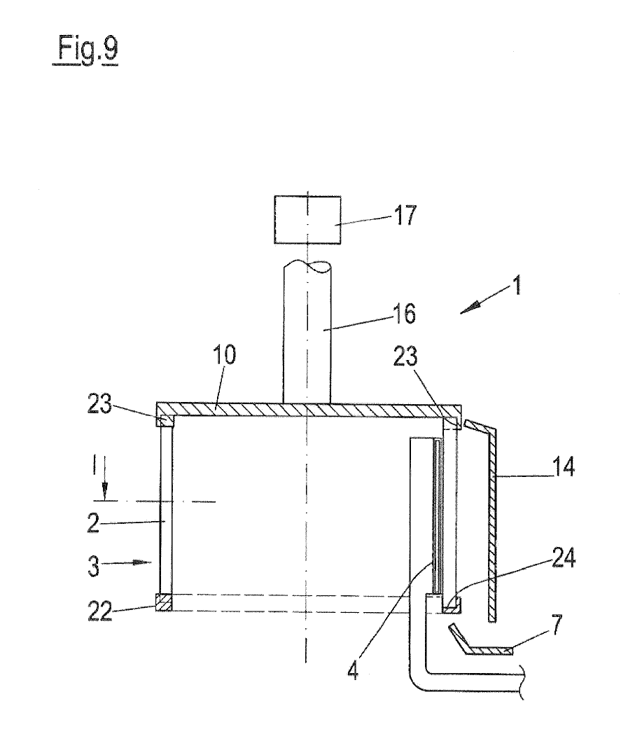

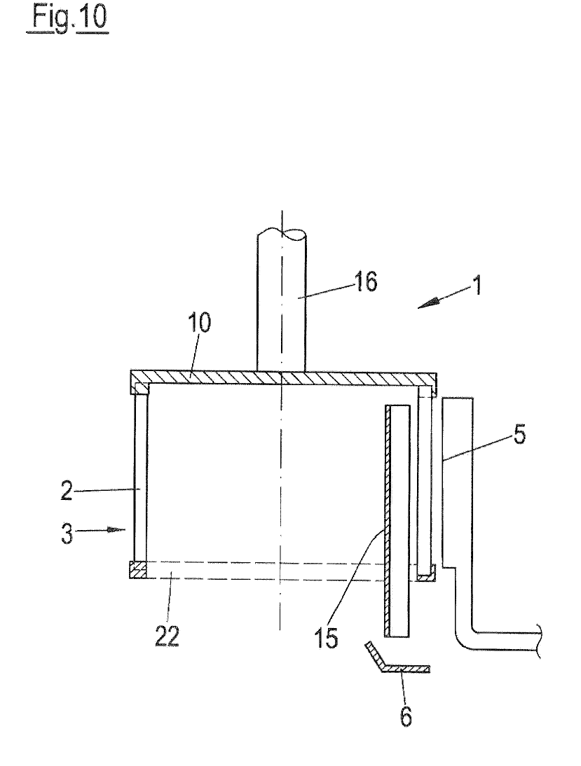

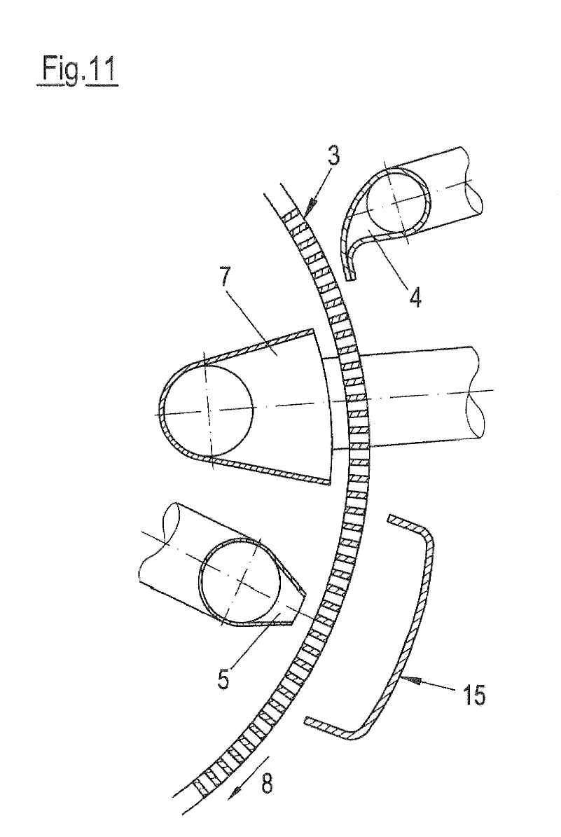

The fractionator shown in FIGS. 8 to 10 for separating pulp fibers contained in a liquid such as water in accordance with their size has a screen element 1 in the form of a cylindrical drum, whose wall is formed by a plurality of individual vertical lands in the form of rods 2.

In this case, the upper ends of the rods 2 are fixed to the circumference of an upper horizontal circular cylinder side disk 10, and the lower ends are fitted to a lower horizontal circular ring 22, which is spaced apart from the side disk 10.

The circular side disk 10 is fixed to the lower end of a vertical shaft 16, which is connected to a rotary drive motor 17, shown schematically.

The vertical lands are identical and distributed regularly on the circumference of the cylindrical drum, in order to form between themselves screen openings in the form of regularly distributed vertical slots 3. Here, the vertical lands have rectangular cross sections and are arranged in the manner of rays, their long sides also extending between the inside and the outside of the drum.

For instance, the diameter of the cylindrical drum can lie in the range from 500 to 800 mm, the rectangular cross section of the lands can be such that their width lies in the range from 0.4 to 0.6 mm and their length lies in the range from 4 to 6 mm.

Furthermore, the length of the lands between the side disk 10 and the ring 22 lies in the range from 150 to 600 mm, and the width of the vertical slots between the lands lies in the range from 1.4 to 1.6 mm.

The rods 3 can be fixed via cutouts 23, 24 in the side disk 10 and in the ring 22. The cutouts 23 in the side disk 10 are preferably open toward the bottom and radially toward the inside or outside, and the cutouts 24 in the ring 22 are open toward the top and radially toward the inside or outside.

The fixing of the lands in the positioning cutouts 23 and 24 can be ensured by any known means, for example by adhesive bonding, by clamping with force or with the aid of conventional retaining elements.

The distance between the lands can also be defined via spacer plates.

At a feed station, the separating apparatus contains nozzles 4 in order to lead the fibrous material suspension toward the inner face of the cylindrical drum, tangentially with respect to this surface and in the rotational or circumferential direction 8 of the cylindrical drum.

These nozzles 4 contain a vertical container, which is arranged in the drum and by means of which a line is connected to a source for the fibrous material suspension to be treated.

Here, the nozzles 4 point in the direction of movement 8 of the drum and have a nozzle opening in the form of a vertical slot, this vertical nozzle slot being located in the vicinity of the inner surface of the cylindrical drum.

Thus, the fibrous material suspension to be treated leaves the nozzle slot tangentially with respect to the inner surface of the cylindrical drum and in the direction of rotation 8 of the drum. The fibrous material suspension in so doing forms a thin suspension layer 18 on the inner surface of the cylindrical drum. Such an arrangement is designed to form a thin suspension layer 18 at the outlet from the vertical nozzle slot, in which layer the fibers, in particular the long fibers 19, are for the most part oriented in the rotational or circumferential direction 8 of the cylindrical drum 8.

For instance, the vertical nozzle slot extends over the major part of the height of the vertical lands or rods 2; the width thereof can lie in the range from 1.3 to 1.7 mm.

At a first separating station, the separating apparatus has a large deflecting wall 14, which is arranged vertically and at a distance from the outer surface of the cylindrical drum. This deflecting wall 14 begins approximately in the region of the opening of the nozzle 4 and extends further in the direction of movement 8 of the drum. Arranged under the deflecting wall 18 is a collecting trough 7 for the short fibers 20.

At a second separating station, which follows the first separating station in the direction of movement 8, the separating apparatus has a fluid nozzle 5 arranged outside the drum.

This fluid nozzle 5 also has a nozzle opening in the form of a vertical slot but which is oriented radially in the direction of the drum. The vertical slot extends over the major part of the height of the drum and directs a fluid under pressure, for example compressed air, onto the drum.

At this second separating station, the separating apparatus has a large deflecting wall 15, which is arranged vertically and at a distance from the inner surface of the cylindrical drum, opposite the fluid nozzle 5. Installed under the deflecting wall 15 is a collecting trough 6 for the long fibers 19.

The separating apparatus described here can operate in the following way.

The speed of the cylindrical drum and of the fibrous material suspension fed in is the same at the outlet from the fibrous material suspension nozzle 4. For example, the circumferential speed of the cylindrical drum can lie in the range from 5 to 20 meters per second.

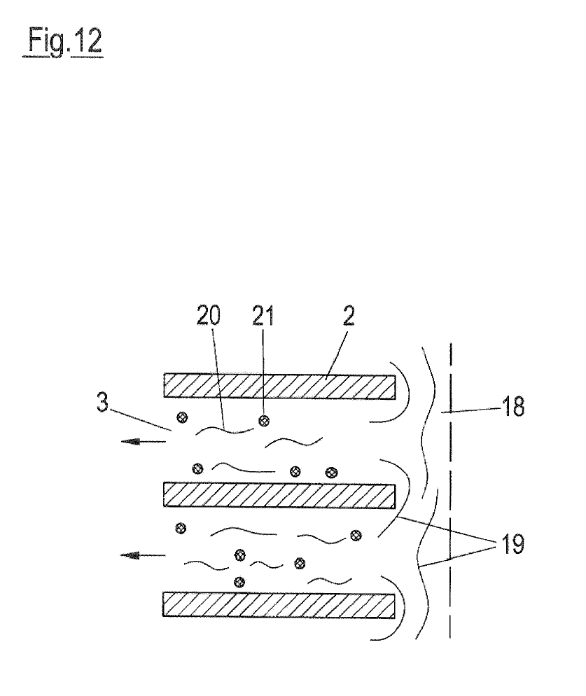

At the first separating station, the fibrous material suspension to be treated, which is deposited on the inner surface of the drum, is at least partly driven through the vertical slots of the drum under the action of centrifugal force and carries with it the short fibers 20 and mineral particles or contents 21 contained therein, while the long fibers 19 are retained within the drum by means of the vertical lands, as shown in FIG. 12.

This retention of the long fibers 19 by means of the vertical lands is made considerably easier by the fact that they are at least for the major part oriented in the rotational or circumferential direction 8 of the drum when the thin suspension layer 18 is formed at the outlet from the nozzle 4.

The liquid splashes outside the drum, which contain the short fibers 20 and the particles 21, are stopped by the deflecting wall 14 and fall into the collecting trough 7.

At the second separating station, under the action of the blown stream which originates from the fluid nozzle 5 and flows through the vertical slots 3 in the drum, the long fibers 19 are detached in the direction of the interior of the drum and are thereby stopped by the deflecting wall 15, falling into the collecting trough 6.

From the description just given, it emerges that the separating apparatus is able to operate continuously by virtue of an uninterrupted flow of a fibrous material suspension to be treated, which emerges from the nozzle 4, the uninterrupted rotation of the cylindrical drum and the uninterrupted blown stream at the outlet from the fluid nozzle 5.

Because of the relatively fast actions of the centrifugal force and of the blowing, the equipment described above, which is assigned to the cylindrical drum at the feed station and at the first and at the second separating station in order to form a separating apparatus, needs to extend only over part of the circumference of the cylindrical drum. It is then possible to provide a plurality of separating apparatuses which are assigned to the cylindrical drum and distributed on the circumference.

In a design variant shown in FIG. 11, a separating apparatus contains a cylindrical drum which is assigned the following equipment, which replaces the equipment from the preceding example.

At a feed station, the separating apparatus contains a nozzle 4 arranged outside the drum for feeding in a fibrous material suspension, having a nozzle opening in the form of a vertical slot. Via this nozzle 4, the fibrous material suspension to be treated is applied in an analogous way to the outer surface of the drum in the direction of rotation 8 of the drum, a suspension layer 18 being formed on the outer surface.

At a first separating station, the separating apparatus inside the drum, beginning approximately opposite the nozzle 4 in the direction of rotation 8, has a collecting trough 7 in the form of a suction bell that is connected to a vacuum source and extends vertically over the drum.

This suction bell is intended to permit at least some of the thin suspension layer 18, which carries the short fibers 20 and the particles 21 therewith, to be sucked through the vertical slots 3 of the drum, while the long fibers 19 are retained by the vertical lands on the outer surface of the drum.

At a second separating station, which is located after the suction bell in the direction of rotation 8 of the drum, the long fibers 19 are released and thrown outward under the action of centrifugal force. The separating apparatus here contains a vertical deflecting wall 15, which is arranged outside the drum and is intended to stop these splashes. As in the preceding example, the long fibers 19 can fall into a collecting trough 6.

At the second separating station, the separating apparatus within the drum can also have a fluid nozzle 5 having a nozzle opening in the form of a vertical slot, which directs a pressurized fluid radially onto the drum.

This fluid nozzle 5 can, for example, produce a stream of water which flows through the vertical slots of the drum, in order to make it easier to detach the fibers and to ensure cleaning of the drum.

In another design variant, the drum could also be formed by a perforated cylindrical screen element 1, the perforation being formed by slots, drilled holes or the like.

Furthermore, it can be advantageous to arrange the drive 17 under the drum. In this case, the fibers would have to be carried away out of the region of the drive 17.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An arrangement for fractionating a fibrous material suspension, which is suitable for producing a web of one of paper, board, tissue, and another fibrous material, into a short fiber fraction with a high proportion of at least one of a plurality of at least one of short and stiff fibers and a plurality of vessel cells and a long fiber fraction with a high proportion of at least one of a plurality of at least one of long and flexible fibers, said arrangement comprising:
at least one nozzle;
a screen element including a plurality of screen openings, a first side that faces said nozzle, and a second side which is opposite said first side, at least one said nozzle being configured for directing a jet of the fibrous material suspension onto said screen element, said screen element being configured for being led past at least one said nozzle configured for directing said jet of the fibrous material suspension onto said screen element, said first side of said screen element being configured for collecting thereon the long fiber fraction, said second side of said screen element being configured for collecting thereon the short fiber fraction, said screen element being cylindrical with a cylinder axis and being mounted such that said screen element is configured for rotating about said cylinder axis.

2. The arrangement as claimed in claim 1, wherein a predominant part of said plurality of screen openings are formed respectively as a plurality of elongated slots, at least in some sections of said screen element, running in a direction of movement of said screen element.

3. The arrangement as claimed in claim 2, wherein all of said plurality of screen openings are formed respectively as said plurality of elongated slots, at least in some sections of said screen element, running in said direction of movement of said screen element.

4. The arrangement as claimed in claim 2, wherein said cylinder axis of said screen element runs approximately vertically.

5. The arrangement as claimed in claim 2, wherein said screen element is formed by a plurality of rods.

6. The arrangement as claimed in claim 5, wherein said screen element is formed as a cylinder with said cylinder axis, said plurality of rods extending over an entire length of said cylinder and being spaced apart from one another.

7. The arrangement as claimed in claim 5, wherein said plurality of rods have a round cross-section.

8. The arrangement as claimed in claim 5, wherein said plurality of rods have a rectangular cross-section with two long side surfaces.

9. The arrangement as claimed in claim 8, wherein said two long side surfaces run radially.

10. The arrangement as claimed in claim 5, wherein said screen element includes a bottom which is open.

11. The arrangement as claimed in claim 5, wherein the arrangement includes a plurality of said nozzle, said plurality of nozzles being arranged inside said screen element.

12. The arrangement as claimed in claim 11, further including a collecting trough for the long fiber fraction, said collecting trough for the long fiber fraction being arranged underneath said screen element.

13. The arrangement as claimed in claim 12, wherein at least in each case a pressurized fluid nozzle is arranged outside said screen element after a respective said nozzle in said direction of movement and is configured for directing a fluid onto said screen element.

14. The arrangement as claimed in claim 13, wherein said fluid is one of water, steam, and compressed air.

15. The arrangement as claimed in claim 13, further including at least one collecting trough for the short fiber fraction, said at least one collecting trough for the short fiber fraction being arranged outside said cylindrical screen element, at least one of opposite and underneath a respective said nozzle.

16. The arrangement as claimed in claim 5, wherein the arrangement includes a plurality of said nozzle, said plurality of nozzles being arranged outside said screen element.

17. The arrangement as claimed in claim 16, further including a collecting trough for the short fiber fraction, said collecting trough for the short fiber fraction being arranged inside said screen element.

18. The arrangement as claimed in claim 17, further including a vacuum source, said collecting trough for the short fiber fraction being connected to said vacuum source.

19. The arrangement as claimed in claim 17, wherein at least in each case a pressurized fluid nozzle is arranged inside said screen element after a respective said nozzle in said direction of movement and is configured for directing a fluid onto said screen element.

20. The arrangement as claimed in claim 19, wherein said fluid is one of water, steam, and compressed air.

21. The arrangement as claimed in claim 19, further including at least one collecting trough for the long fiber fraction, said at least one collecting trough for the long fiber fraction being arranged outside said screen element, at least one of opposite and underneath a respective said pressurized fluid nozzle.

22. An arrangement for fractionating a fibrous material suspension, which is suitable for producing a web of one of paper, board, tissue, and another fibrous material, into a short fiber fraction with a high proportion of at least one of a plurality of at least one of short and stiff fibers and a plurality of vessel cells and a long fiber fraction with a high proportion of at least one of a plurality of at least one of long and flexible fibers, said arrangement comprising:
at least one nozzle;
a screen element including a plurality of screen openings, a first side that faces said nozzle, and a second side which is opposite said first side, at least one said nozzle being configured for directing a jet of the fibrous material suspension onto said screen element, said screen element being configured for being led past at least one said nozzle configured for directing said jet of the fibrous material suspension onto said screen element, said first side of said screen element being configured for collecting thereon the long fiber fraction, said second side of said screen element being configured for collecting thereon the short fiber fraction, a predominant part of said plurality of screen openings being formed respectively as a plurality of elongated slots which, at least in some sections of said screen element, run at an angle to a direction of movement of said screen element.

23. The arrangement as claimed in claim 22, wherein said screen element is cylindrical with a cylinder axis and is mounted such that said screen element is configured for rotating about said cylinder axis.

24. The arrangement as claimed in claim 22, wherein all of said plurality of screen openings are formed respectively as said plurality of elongated slots which, at least in some sections of said screen element, run at said angle to said direction of movement of said screen element.

25. The arrangement as claimed in claim 22, wherein a predominant part of said plurality of elongated slots of said screen element run at a right angle to said direction of movement.

26. The arrangement as claimed in claim 25, wherein all of said plurality of elongated slots of said screen element run at said right angle to said direction of movement.

27. The arrangement as claimed in claim 25, wherein a width of each of said plurality of elongated slots of said screen element is between 0.3 and 3 mm.

28. The arrangement as claimed in claim 25, wherein a width of each of said plurality of elongated slots of said screen element is between 0.5 and 1.5 mm.

29. The arrangement as claimed in claim 25, wherein a predominant part of said plurality of elongated slots of said screen element are formed identically.

30. The arrangement as claimed in claim 25, wherein all of said plurality of elongated slots of said screen element are formed identically.

31. The arrangement as claimed in claim 25, wherein a predominant part of said plurality of elongated slots of said screen element are oriented identically.

32. The arrangement as claimed in claim 25, wherein all of said plurality of elongated slots of said screen element are oriented identically.

33. The arrangement as claimed in claim 22, wherein said screen element is formed as an endlessly circulating, flexible screen belt.

34. The arrangement as claimed in claim 33, wherein said screen belt consists of plastic.

35. The arrangement as claimed in claim 33, wherein said screen belt is formed by a plurality of rods spaced apart transversely with respect to said direction of movement of said screen element and from one another.

36. The arrangement as claimed in claim 35, wherein said plurality of rods are connected to one another at least one of at a plurality of ends of said plurality of rods and at specific intervals transversely with respect to said direction of movement.

37. The arrangement as claimed in claim 35, further including a plurality of rotating guide rolls, said screen belt being deflected over said plurality of rotating guide rolls.

38. The arrangement as claimed in claim 37, wherein said screen belt includes a plurality of elevated running surfaces, said screen belt being in contact with said plurality of rotating guide rolls only via said plurality of elevated running surfaces.

39. The arrangement as claimed in claim 37, wherein the arrangement includes a plurality of said nozzle, said plurality of nozzles being arranged only on the first side of said screen belt and in each case are configured for directing a jet of the fibrous material suspension into a respective inlet pocket between said screen belt and a respective one of said plurality of rotating guide rolls.

40. The arrangement as claimed in claim 39, further including a collecting trough for the long fiber fraction and a collecting trough for the short fiber fraction, said collecting trough for the long fiber fraction being arranged on one of the first side and the second side of said screen belt and said collecting trough for the short fiber fraction being arranged on an opposite side of said screen belt.

41. The arrangement as claimed in claim 22, wherein a total area of said plurality of screen openings is more than 50% of a total area of said screen element.

42. The arrangement as claimed in claim 22, wherein a land width between said plurality of screen openings is less than 2 mm.

43. The arrangement as claimed in claim 22, wherein a land width between said plurality of screen openings is less than 1 mm.

44. The arrangement as claimed in claim 22, wherein a land width between said plurality of screen openings is between 0.3 and 0.8 mm.

45. The arrangement as claimed in claim 22, wherein a thickness of said screen element is more than two times an average land width between said plurality of screen openings.

46. The arrangement as claimed in claim 22, wherein a thickness of said screen element is more than three times an average land width between said plurality of screen openings.

47. The arrangement as claimed in claim 22, wherein the arrangement includes a plurality of said nozzle, said plurality of nozzles in each case being configured for directing at least one jet of the fibrous material suspension onto said screen element.

48. An arrangement for fractionating a fibrous material suspension, which is suitable for producing a web of one of paper, board, tissue, and another fibrous material, into a short fiber fraction with a high proportion of at least one of a plurality of at least one of short and stiff fibers and a plurality of vessel cells and a long fiber fraction with a high proportion of at least one of a plurality of at least one of long and flexible fibers, said arrangement comprising:
at least one nozzle;
a screen element including a plurality of screen openings, a first side that faces said nozzle, and a second side which is opposite said first side, at least one said nozzle being configured for directing a jet of the fibrous material suspension onto said screen element, said screen element being configured for being led past at least one said nozzle configured for directing said jet of the fibrous material suspension onto said screen element, said first side of said screen element being configured for collecting thereon the long fiber fraction, said second side of said screen element being configured for collecting thereon the short fiber fraction, said screen element having a honeycomb structure.

49. The arrangement as claimed in claim 48, wherein said screen element is cylindrical with a cylinder axis and is mounted such that said screen element is configured for rotating about said cylinder axis.

50. The arrangement as claimed in claim 48, wherein said screen element is formed as an endlessly circulating, flexible screen belt.
